(19) United States
(12) Patent Application Publication
(10) Pub. No.: US 2006/0187485 A1
(43) Pub. Date: Aug. 24, 2006

(54) Method for monitoring of a directory in a computer system, computer program product and computer system for execution of this method

(76) Inventors: Herman Lankreijer, Hofsingelding (DE); Viktor Benz, Kirchseeon (DE)

Correspondence Address: SCHIFF HARDIN, LLP;PATENT DEPARTMENT, 6600 SEARS TOWER, CHICAGO, IL, 60606-6473, US

(21) Appl. No.: 11/351,105

(22) Filed: Feb. 9, 2006

(30) Foreign Application Priority Data
Feb. 24, 2005 (DE) 10 2005 008 519.9

(51) Int. Cl. G06F 3/12

(52) U.S. Cl. 358/1.15

(57) ABSTRACT

In a method for monitoring of a directory in a computer system as to whether a new file has been generated in the directory, a stored directory modification time is compared with a current directory modification time. The directory is checked in detail in the event that the current directory modification time differs from the stored directory modification time. With the method, a detailed check does not always have to be executed, so that significant processor capacity is saved. Also, for monitoring of a directory in a computer system as to whether a new file has been generated in a directory, a check is made for existence of a trigger file, and when the trigger is present, the print job is supplied for the further processing.

### BACKGROUND

The preferred embodiment concerns a method for monitoring of a directory in a computer system, in particular in a printing system, whereby a new file has been generated in the directory, a computer program product and a printing system for execution of the method. It in particular concerns the handling of print jobs that are sent to high-capacity printing systems whose printing speed is approximately 40 pages per minute, up to over 1000 DIN A-4 pages per minute.

To process such print jobs, print servers are frequently used that receive the print data from a data source, prepare these for printing (whereby under the circumstances they are converted from a first data format to a second data format suitable for a specific printer) and finally transfer such a converted data stream directly to a connected printer.

In the publication “Das Druckerbuch”, Dr. Gerd Goldmann (HSG), 6th edition (May 2001), Océ Printing Systems GmbH, Poing, what are known as Océ PrismaPro server systems are described in chapter 14 that are in the position to process the aforementioned print jobs. For this, various system components are provided that provide for an extensive automation in the generation of a print job. Print jobs can be generated by means of a print job manager on an arbitrary client console on a client network, and these print jobs can be transferred to an order distribution system.

The processing of print jobs in a print production environment significantly depends on enabling an optimally high-performance, flexible processing of the print jobs in order to achieve a high utilization of the connection production printer and with it a high productivity.

A typical print data format in an electronic production printing environment is the format AFP (Advanced Function Presentation) which, for example, is described in the publication Nr. F-544-3884-01 by the company International Business Machines Corporation (IBM) with the title “AFP Programming Guide and Line Data Reference”.

A method for automated acceptance and forwarding of document processing jobs is known from WO 03/065197, in which, to generate a print job from at least one file, the file is transferred into a specific directory of a receipt server, the directory is automatically checked with regard to newly-arrived files at regular (in particular configurable) time intervals; and a new print job is generated from each newly-arrived file, or the file is added to an existing print job for further processing. Three possibilities are hereby provided as to how the control of the acceptance and forwarding of the print jobs occurs. According to the first possibility, the buffered files contain only print data, whereby a predetermined control file (default job ticket) is used for printing of these print data. In a second possibility, a job-individual control file (job ticket) is used. In the third possibility, the files contain print data and respectively exhibit parameterized file names for further processing. The further print process is controlled using the parameters specified in the file names.

The designation of “print job” is used in this document for the files that are generated via such a method for automatic acceptance and forwarding of document processing jobs. Given such a print job it is not possible to add further files.

This known method proved its worth well. However, due to the development that occurred in recent years of distributing print jobs to different printers over data networks, the data volume that is to be processed by one server has steadily increased. A significant need has hereby arisen for a method for automated acceptance and forwarding of document processing jobs that can handle such large data volumes quickly and flexibly.

It is known to monitor the input of new files into a directory of a print server. In the conventional method, a directory is opened, meaning that a corresponding directory modification file is opened that contains an entry for each file stored in the respective directory. The content of this file is read and all files that have previously not yet been registered by the control program for the further processing are detected and registered.

All directories are sequentially checked, and the checking begins anew with the first directory when the last directory has been checked. This is a polling method that is executed repeatedly, whereby a plurality of configuration files are to be opened and read completely given each pass. Polling methods in which such intensive read processes are to be executed require a significant processor capacity.

### SUMMARY

It is an object to achieve a method for monitoring of directories in a computer system (in particular a printing system) as to whether a new file has been generated in the directory, which method requires less computation capacity than conventional methods and can be executed simply and quickly. Furthermore, it is an object to achieve a computer program product for execution of the inventive method as well as a corresponding printing system.

In a method for monitoring of a directory in a computer system as to whether a new file has been generated in the directory, a checking of the directory is repeatedly executed as to whether a new file has been generated, the checking comprising the steps of leading a current directory modification time that corresponds to a point-in-time of a last modification of the corresponding directory, the current directory modification time is compared with a stored modification time, and, given a difference between the two directory modification times, this is assessed as a modification of the respective directory since a last check of the respective directory, and in the event that such a modification of the directory has occurred, examining the directory by a detail check for new files generated in the directory, and storing the current modification time.

Also, for monitoring of a directory in a computer system as to whether a new file has been generated in a directory, a check is made for existence of a trigger file, and when the trigger file is present, the print job is supplied for the further processing.

### BRIEF DESCRIPTION OF THE DRAWINGS

FIG. 1 is a high-capacity printing system;

FIG. 2 shows schematically the design of a control program;

FIGS. 3a, 3b show schematically in a block diagram, a method for checking whether new files have been entered in specific directories; and

FIG. 4 shows schematically a module of the control program in a block diagram.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

With the method of the preferred embodiment, directories in a computer system are monitored as to whether a new file has been generated in the directory, whereby a checking of the directories is repeatedly executed as to whether a new file has been generated in the respective directories, and the checking comprises the following steps:

reading of a current directory modification time that corresponds to the point in time of the last modification of the corresponding directory,

comparison of the current directory modification time with a stored directory modification time, whereby given a difference between the two directory modification times this is assessed as a modification of the respective directory since the last check of this directory, and

in the event that such a modification of the directory has occurred, the directory is examined by means of a detailed check for new files generated in the directory, and the current modification time is stored.

Due to the comparison of the current directory modification time with the stored directory modification time, a detailed check (for example via reading of the directory configuration file) does not have to occur given each check. The checking of individual directories can thus be executed significantly faster and more simply than is the case in conventional methods. This leads to a clear reduction of the requirement for processor capacity.

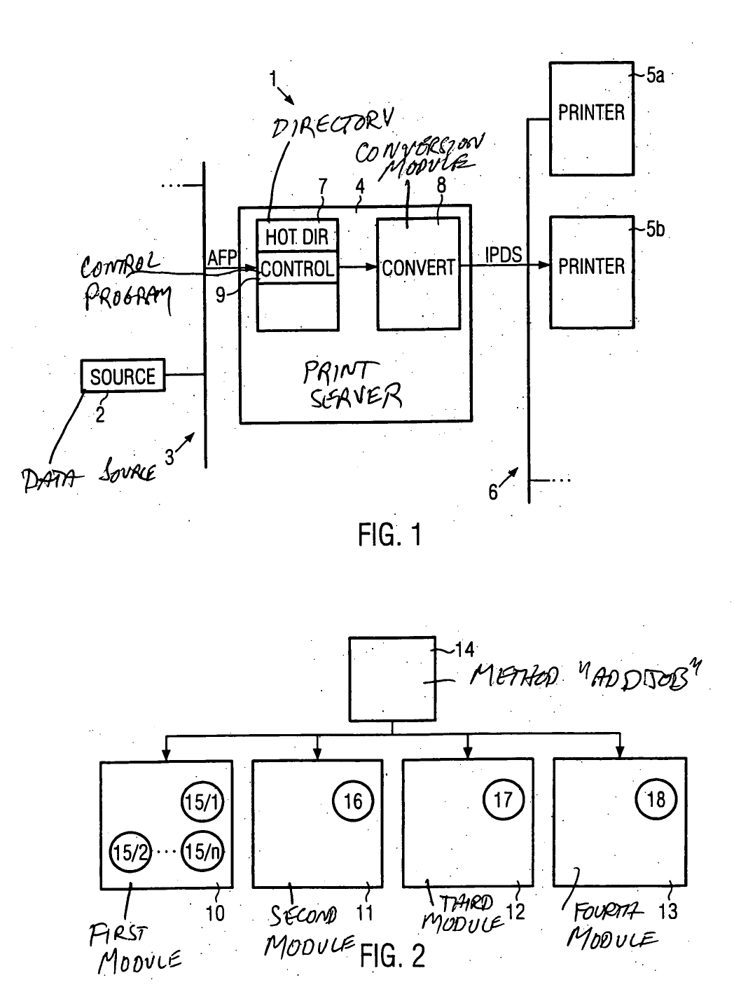

A printing system 1 is shown in FIG. 1 in which print data is transmitted from a data source 2 (such as a host computer, a tape drive, an application computer or the like) over a first network 3 to a print server 4. The data transfer thereby occurs per file, whereby multiple files can belong to a specific print job. In conventional methods, multiple files can be combined into one print job only when a special control file (which is designated as a job ticket) is used. A specific storage range, i.e. a main directory with, if applicable, further sub-directories can respectively be provided in the print server 4 for each print job, in which directories are stored all files belonging to the print job as soon as they have arrived at the print server 4. Alternatively, it is also possible that a single directory 7 is provided for multiple incoming print jobs.

In principle, the incoming print jobs are converted in a conversion module 8 into a data stream adapted to the respective printer. In the present example, a plurality of print devices 5a, 5b are connected to the print server 4 over a second network 6, whereby the print data are transferred between the print server 4 and the printing devices 5a, 5b in the language IPDS (Intelligent Printer Data Stream) adapted to the printer.

The automatic acceptance and forwarding of document processing jobs, in particular of print jobs, is controlled by means of a control program. The control program is advantageously a program that runs in the background, whereby typically no direct user interaction occurs. Such programs are designated as daemons (Disc and Execution Monitor) under Unix and its derivatives. In Microsoft Windows®, the corresponding programs are called “services”. A daemon can also run when no user is logged onto the computer. A smooth running is thus ensured, even when no user is directly, actively operating at the computer.

The control program 9 is designed in a modular manner, whereby its rough structure is schematically shown in FIG. 2 as a block diagram. The control program comprises four modules 10, 11, 12, 13.

The first module 10 checks a directory to be monitored for the input of new files. New incoming files are detected or registered by the control program 9 and marked for further processing.

The second module 11 checks whether input files or print jobs are finished. This module operates according to a known method principle. This known method principle is based on the polling of all processes, whereby it is determined whether the processes have opened a specific file in the directory to be monitored. The third module 12 arranges multiple print jobs in the correct order to be printed. This module is designated as “job sequencing”.

With the fourth module 13, the print jobs are forwarded to the conversion module 8 for printout on a printer 5a, 5b.

Upon starting the control program 9, blank job templates that are not yet related to a concrete print job are placed in job lists 15/1 through 15/n of the module 10 for directories entered into a configuration file of the control program 9. The job templates (still independent of jobs) are designated as sample (draft) job templates. In these sample job templates, specific parameters are entered for the respective directories and specific methods are associated with the parameters, which methods are executed in the processing of the individual job templates in one of the modules 10 through 13. The directories for acceptance of print files are subsequently placed on a storage medium when they are not yet already present.

The processing of the individual print jobs in the modules 10 through 13 is controlled by a method “AddJob” 14.

The module 10 contains multiple job lists 15/1, 15/2 through 15/n that respectively contain preliminary print jobs that are designated as jobs.

In the method of the preferred embodiment, differentiation is made between three types of print jobs. There are print jobs that are comprised of only a single print data file. There are print jobs that comprise one or more print data files and one job ticket, whereby in which order the print files of the print job are to be printed is regulated in the job ticket. There are print jobs that comprise one or more print data files and one trigger file (explained below) and optionally still comprise a job ticket, whereby the order in which the print files of the print job are to be printed is not regulated in the trigger file, but rather only in the job ticket.

The jobs are processed with different sampling rates, whereby a list is respectively provided for jobs of a specific sampling rate.

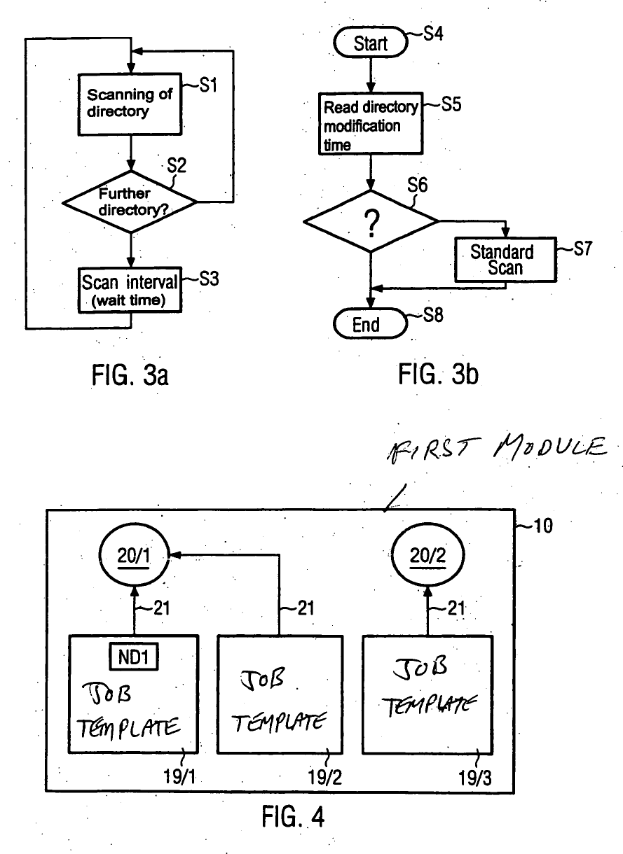

If a new print job ND1 is generated in one of the directories to be monitored, the files belonging to this print job are detected by the module 10 according to using a method explained in detail below and shown in FIGS. 3a, 3b. The module 10 hereupon copies a sample job template prepared for the directory from one of the corresponding lists 15/1 through 15/n and supplements the copied job template (that is associated with the directory in which the print job ND1 has been generated) via the parameters belonging to the job, such as, for example, its name, the trigger file name etc. This job template, thus individualized for a specific job (i.e. a preliminary print job), is stored in one of the further modules 11 through 13 for the further processing of the job.

By which modules a specific job is to be processed is entered into its job template or into the configuration file of the control program 9. The further modules 11, 12 and 13 in turn comprise job lists 16, 17 and 18 in which the job templates are recorded or received. The transfer of the job templates from one of the lists of a module to another list of a different module occurs merely via alteration of a corresponding pointer, which is executed by the method “AddJob” 14.

The individual modules are decoupled from one another due to the presence of the job lists, whereby it is also possible that all modules are not always executed given processing of a specific print job; rather, in particular the modules 11 and/or 12 can be omitted as needed. Due to the decoupling of the individual modules, the individual jobs can be processed independent of one another, which is why it is not necessary that a module for execution of a specific job must wait until a different module is finished with the execution of a different job, whereby delays in the execution of the individual jobs are avoided.

The module 10 serves for monitoring of the input of new files. It is already known to monitor the input of new files in a directory of a print server. In the conventional method, a directory is opened, meaning that a corresponding directory configuration file is opened that contains an entry for each file stored in the respective directory. The content of this file is read, and all files that have previously not yet been registered by the control program for the further processing are detected and registered.

All further directories are subsequently opened in succession until all directories have been checked. The check as to whether new files have arrived (in comparison to the preceding query) subsequently begins again at the first directory and is repeated for all further directories. This regular opening and checking of files is also generally designated as polling. Polling methods in which a comprehensive processing occurs in each polling step require significant calculation capacity and thus delay the automatic processing of the print jobs on the print server 4.

The method for regular checking of a directory, shown in FIGS. 3a and 3b, is therefore executed with the preferred embodiment.

FIG. 3a shows a method with which a program for scanning of a directory (step S1) is repeatedly invoked in an endless loop. After the step S1, a query (step S2) occurs in which it is checked whether a further directory is to be scanned. The next entry is thus read from the corresponding job list 15 in module 10. If such an entry is present, the method workflow transitions to the step S1 again and the program for scanning of this further directory is invoked.

In contrast to this, if it is established in step S2 that all directories have been scanned, the method workflow transitions to the step S3, with which it pauses (corresponding to a predetermined scan interval) until the scanning passes again to the step S1 and the scanning of the first directory of the job list 15 is begun. A method according to FIG. 3a is started for each job list, whereby the individual methods are adjusted to different sampling rates (i.e. different scan intervals).

FIG. 3b shows a scanning program of the preferred embodiment that is invoked in the step S1. This scan program begins with the step S4.

In the subsequent step S5, a directory modification time of the directory is read and the current time is determined.

In step S6 it is checked whether: 1., the read directory modification time is identical to a directory modification time determined for the directory from one of the preceding scan processes; and 2., whether the current time differs from the stored directory modification time or, the read directory modification time by a time interval that at least corresponds to the smallest time unit with which the directory modification time is detected.

If one of the two conditions is not fulfilled, the method workflow passes to the step S7, in which a conventional standard scanning or detailed check of the directory occurs as it is known from the prior art, in that the directory configuration file is read and it is determined whether not yet detected and registered files are contained in this. If such a file is determined, it is recorded in step S7 and registered via copying and supplementation with the parameters (specific to the print job) of a corresponding job template, as is described above. In step S7, the current directory modification time of the directory is additionally stored in a corresponding job template.

With the first condition of the query from step S6, it is checked whether the directory has been modified since the preceding scan event (S7). When this is not the case, no file has been generated in the directory. The files thus do not have to be individual checked. With the second condition, it is ensured that the scanning according to the step S5 was executed with no such short temporal interval (relative to the last complete scan (step S7) that is smaller than the smallest time unit that can be established with the directory modification time. If the directory modification time is, for example, measured in units of 1/10 of a second, the scanning according to step S7 and the scanning according to step S5 can occur within 1/10 of a second, whereby the same directory modification time would be displayed. Nevertheless, it would be possible that the files in the directory have been changed in the intervening time period. In order to remedy this problem, both conditions must be fulfilled.

In the first pass of the method according to FIG. 3b, no directory modification time is yet stored in the corresponding job template. The read directory modification time therefore always differs from the not-present stored modification time, and in step S6 the method branches to the step S7, in which the directory is initially completely checked and the current directory modification time is stored in the job template.

If the query in step S6 yields that both conditions are fulfilled for the directory, the result of the query is then a “yes” and the method workflow passes to the step S8, with which this program for scanning of a directory is ended. The method workflow then passes again to the step S2 according to the method from FIG. 3a.

In the standard scan in step S7, via opening and reading of the directory configuration file it is checked whether the files listed therein are already recorded by the control program 9 and have been registered for the further processing. The standard scan is also designated as a detailed check, since here the directory configuration file is completely read.

The adherence to observance of the time interval according to the 2nd condition of the query from step S6 is advantageously realized in that the current read time is reduced to the time unit of the directory modification time, in that the corresponding digits in the count value of the time are discarded. If, for example, the directory modification time is measured in units of 1/10 of a second, the specification of the current time is reduced to the unit of 1/10 sec, even if the current time should be measured significantly more precisely. All digits are hereby discarded that concern 1/100 of a second or even smaller time units. Due to the reduction of the time unit of the current time, the checking of the second condition occurs merely via comparison of the current time with the directory modification time; if these two specifications differ, the current time lies outside of the aforementioned time interval.

The readout of only the directory modification time and comparison with the stored directory modification time can be executed significantly more quickly than the reading and checking of the entire directory configuration file. The directory modification time is read out from a directory configuration file that is associated with a directory superordinate to the directory to be examined. For this, corresponding commands such as “stat” or “stats” are provided in the typical operating systems, such as, for example, in Linux.

If this method is executed with the same sampling rate as in a conventional method, significantly less processor capacity is required. The sampling rate is adjustable. In conventional methods it is typically in a range from 1 sec to 5 sec. With the method of the preferred embodiment, the sampling rate can be shortened up to approximately 100 μsec, whereby sampling rates in the range from 100 μsec to 5 sec are possible. In principle, longer sampling rates are also possible, whereby longer sampling rates than 20 sec are for the most part not advisable. Sampling rates in the range from 10 msec to 5 sec are normally appropriate. The sampling rate can advantageously be set in a configuration file for the directory to be scanned as a multiple (for example ×1, ×10, ×50, ×500) of the set minimal sampling rate of 100 μsec to 1 sec.

The method explained above according to FIG. 3b is designated as a FastScan or fast check. In the configuration of the directories it can be established whether the respective directory is to be monitored with a conventional scanning method or by means of FastScan new files. Given the entry of the job template into the job list of the module 10, for this a pointer is entered into the respective job template that points to the methods of FastScan or, respectively, the methods of a conventional standard scan. The conventional scan comprises only the step S7, whereby here the storage of the directory modification time can be omitted. A scan exclusively with the conventional standard scan (=detailed check) is appropriate when new files are generated in the directory in very short chronology [temporal succession], whereby here the chronology must be extremely short. However, this is only seldom the case, which is why FastScan is significantly faster for most directories than the conventional scanning by means of a standard scan.

The module 11 for checking whether print jobs are completed is subsequently explained in detail.

This check conventionally occurs in that it is determined whether a file is still open. If the file is no longer open, it is assumed that the process that had written the file has concluded the processing of this file. This is also applicable in most cases. However, given a crash of a process or of a computer that writes a file, the file that is not yet completely finalized is also closed. This has the result that an incomplete file is supplied for further processing. Misprints and expenses are thus generated.

In the preferred embodiment, instead of the module 11 the module 10 can be designed such that routines for writing of files of a print job are provided in directories that generate a trigger file after complete creation of the print job in the directory. A complete creation of the print job means that, on the one hand, all files belonging to the print job are completely generated and, on the other hand, that all processes relevant for the writing of the files of the print job have been ended without errors. For example, this trigger file exhibits the same name as the print job, whereby, however, a specific change (such as, for example, “.trig”) is appended to the file name. The trigger file itself contains no data.

Before the print job is supplied for further processing, it is checked in the module 10 whether a corresponding trigger file is present. When the trigger file is present, the print job (i.e. the corresponding job template) is supplied for further processing.

The checking of the presence of a trigger file can be executed with the scanning method described above using FIG. 3, whereby in step S7 it is established whether a trigger file has been created. Thus no further monitoring routines are then necessary to monitor whether files have been completely finished. Given such an embodiment of the module 10, the module 11 can be omitted in the monitoring of the directories, meaning that the print jobs are directly forwarded to either the module 12 or the module 13.

The generation of a trigger file ensures that no incomplete print jobs are supplied to the further processing event, and that all processes relevant for the writing of the print job have been ended without errors.

Either the trigger file is generated by an application program with which a new file is written in the directory to be monitored, or the operating system commands for writing a file in a directory (such as, for example, write or move) are designed such that they automatically generate a trigger file. However, the generation of the trigger file is not executed by the control program 9, which can merely monitor the generated trigger file.

The trigger file is deleted when the print job completed by the control program 9 is forwarded as a print job to the conversion module 8.

The module 12 “job sequencing”, with which print jobs are arranged in a predetermined order, is explained in the following.

The control program 9 can be configured such that it either

1. does not sort print jobs,

2. sorts print jobs that are stored in a specific file directory in a specific order (module 12), or

3. sorts print jobs stored distributed across multiple file directories in a specific order (module 12).

Methods according to 1. and 2. are already known from the prior art. In these conventional methods for sorting of a print job within a file directory, the print jobs are sorted using the file access time that is stored upon generation of the respective file. However, it is hereby disadvantageous that the smallest time unit that is detected with the file access time is typically 1 second. In particular in multi-tasking systems, a plurality of files can be generated in a directory within one second. A reasonable order of these print jobs can thus not always be determined.

These problems are overcome with the module of the preferred embodiment for sorting of print jobs.

Files that belong to different print jobs can often be stored distributed across a plurality of file directories. With the preferred embodiment, multiple print jobs that can also be distributed across multiple directories can also be sorted. The directories for which respectively one job template is applied are designated as main directories in the following. A plurality of sub-directories in which files of a job can also be stored can also be provided in one main directory. There are prepared job templates only for the main directories. The sub-directories are monitored together with the main directory.

A class that comprises methods and parameters is provided for sorting of print jobs stored across multiple directories, which class is designated as a job sequencing class. The configuration file of the control program 9 is designed such that, in the generation of the job template 19 (FIG. 4) for a directory whose print jobs should be sorted, an instance of the job sequencing class is generated and the job template is provided with a pointer 21 that points to this instance 20. An instance is a runtime version of a class, i.e. a program to be executed in working memory of a computer. The pointers 21 of the directories or of the corresponding job templates 19/1, 19/2 in which the print jobs stored therein should be mutually sorted all point to the same instance 20/1. The directories that are associated with a common instance of the job sequencing class can be used for acceptance of a single print job or also multiple print jobs.

The instance 20 contains parameters and routines for generation of successive (i.e. consecutive) job identification numbers. The routine for generation of the job identification number is invoked by the method described above using FIGS. 3a and 3b, and in fact each time when a first file of a new print job is determined, for example in step S7. The corresponding job identification numbers are associated with the files, whereby the sample job template is copied and stored as a job template in which the job identification number has been entered.

The individual print jobs are identified and sorted using the job identification numbers of module 12. Since one job identification number is associated with each print job when this print job is generated in the respective directory, a correct number of the print jobs is obtained in the order in which the respective jobs 19 are accessed for writing of the files in the directories. The danger of errors due to an incorrect time recording is here significantly less than in conventional methods.

Given print jobs with multiple files, the point in time after which the individual print jobs are sorted is the point in time at which the first file of a print job is written (generated) in a directory.

Given use of the module 12 according to the sorting method described above, it is appropriate when the directories are scanned with the FastScan method of the module 10 and the sampling rate is selected high or the sampling interval is selected short, such that the temporal resolution of the detection of the generation of the print jobs is high.

In the method of the preferred embodiment, print jobs can thus be sorted whose files are stored distributed across multiple file directories. The file directories, which contain files of print jobs that are mutually sorted, respectively form a group of directories. Such groups of directories can comprise one or more directories. This method is thus also applicable in order to correctly sort print jobs in a single directory. Naturally, multiple groups of directories can also be provided with the method, whereby the print jobs stored therein can be sorted independent of one another.

In such complex methods for control of document processing jobs, the control program 9 reads control parameters from different sources and stores them in a control file (the job ticket) associated with the document processing job or print job. Conventional control programs are designed such that the last read source for parameters overwrites the corresponding parameters in the control file. The order in which the individual sources are read out cannot be influenced. Should a specific parameter be defined in multiple sources, then it is left to chance which of the values of the different sources is adopted.

The system is provided with a routing “set parameter” (X, Y, Z) with which a priority of a process step X is set dependent on a source Y and a priority Z. Sources for such parameters can be a job-specific job ticket, a sample job ticket (default job ticket), parameters in the print data and parameterized file names. The previously-discussed WO 03/065197 A2 is referenced in this regard. Via the establishment of the priorities for specific process steps dependent on the source, it is ensured that, in the event of a parameter value from a source with a specific priority Z1, the parameter value is not overwritten in the event that it has already been written from another source Y2, whereby the priority Z2 of the source Y2 is higher than the priority Z1 of the source Y1. The priority of the respective source is also stored and associated with the parameter value upon setting of the parameter values. A comparison of the priority with a priority of a further source can hereby occur later.

This consideration of the priorities upon setting of the parameter values is accounted for in the modules 13 upon compilation of the parameter values of the print job for controlling the printing process.

With the last module 13, the automatically received, checked and (if applicable) sorted, completely assembled print jobs are thus forwarded as print jobs to the conversion module 8.

The method explained above can be realized as a computer program product, and comprise the modules 10 through 13 described above. The computer program product can be stored on a data medium.

In operation, the computer program product is stored in the printing system 1 on the print server 4 and is executed there.

The preferred embodiment can be briefly summarized according to the following:

The preferred embodiment concerns a method for monitoring of a directory in a computer system, in particular a printing system, as to whether a new file has been generated in a directory.

The monitoring of directories occurs via comparison of a stored directory modification time with a current directory modification time of the respective directory, whereby the directory is checked in detail in the event that the current directory modification time should differ from the stored directory modification time.

With the method, a detailed check does not always have to be executed, whereby significant processor capacity is saved.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. A method for monitoring of a directory in a computer system as to whether a new file has been generated in the directory, comprising the steps of:
Repeatedly executing a checking of the directory as to whether a new file has been generated in the respective directory, the checking comprising the steps of:
reading of a current directory modification time that corresponds to a point-in-time of a last modification of the corresponding directory
comparing the current directory modification time with a stored directory modification time, and, given a difference between the two directory modification times, this is assessed as a modification of the respective directory since a last check of said respective directory; and
in the event that such a modification of the directory has occurred, examining the directory by a detailed check for new files generated in the directory, and storing the current modification time.

2. A method according to claim 1 wherein the current time is also recorded, and it is determined whether the current time differs from the stored directory modification time or the current directory modification time by a predetermined time interval that corresponds to a smallest time unit with which the directory modification time is recorded, and in the event that the current time does not differ by said predetermined time interval from the directory modification time, the directory is examined by the detailed check for new files generated in the directory.

3. A method according to claim 2 wherein a determination of whether the current time differs from the stored directory modification time or the current directory modification time by a predetermined time interval is executed by reducing the current time to a time unit with which the directory modification time is recorded, and the reduced current time is compared with the directory modification time.

4. A method according to claim 1 wherein the detailed check occurs via reading of a directory configuration file corresponding to the directory.

5. A method according to claim 1 wherein given each repeated check, specific directories are examined exclusively with a detailed check.

6. A method according to claim 1 wherein for the check as to whether a new file has been generated in the directory, it is also checked whether a trigger file is present that is associated with a specific file in the directory and, in the event that such a trigger file is present, the file that is associated with the trigger file is released for further processing.

7. A method according to claim 1 wherein given the check as to whether a new file has been generated in the directory, it is also checked whether a new file belongs to a new print job and whether a job identification number in chronological order is respectively associated for the newly determined print job.

8. A method according to claim 7 wherein the print jobs that are stored in multiple predetermined file directories are associated with chronological job identification numbers.

9. A method according to claim 7 wherein the print jobs are sorted using the job identification numbers before forwarding to a printer.

10. A method according to claim 1 wherein parameters for control of a print job are read out from different sources, whereby priorities are associated with the sources, and in the event that specific control parameters are present in multiple sources, the control parameters are used from those sources that possess a highest priority.

11. A computer program product, comprising a computer program runnable on a computer for monitoring of a directory in a computer system as to whether a new file has been generated in the directory, said computer program performing the steps of:
repeatedly executing a checking of the directory as to whether a new file has been generated in the respective directory, said checking comprising the steps of
reading a current directory modification time that corresponds to a point-in-time of a last modification of the corresponding directory,
comparing the current directory modification time with a stored directory modification time, and, given a difference between the two directory modification times, this is assessed as a modification of the respective directory since the last check of said respective directory, and
in the event that such a modification of the directory has occurred, examining the directory by a detailed check for new files generated in the directory and storing the current modification time.

12. A computer program product according to claim 11 wherein the computer program product is divided into multiple modules whereby the check as to whether a new file has been generated in a directory is executed in one of the modules, and job templates are associated with the files, whereby an order of the processing of the individual print jobs in the individual modules is controlled by job lists in which the job templates belonging to the print jobs are entered to the extent that the corresponding print job should be processed in the corresponding module.

13. A computer program product according to claim 12 wherein upon establishment of a new file of a new print job in a directory, a job template that is associated with the directory in which the file has been generated is generated via copying of a sample job template, and respective parameters belonging to the print job are entered into the job template.

14. A computer program product according to claim 13 wherein predetermined methods that are executed upon the processing of the individual job templates in one of the modules are associated with the job templates.

15. A computer program product according to claim 11 further including a module for checking whether input files or print jobs are finished.

16. A computer program product according to claim 11 further including a module that sorts multiple print jobs into a correct order to be printed.

17. A computer program product according to claim 11 further including a module that forwards print jobs to a printer for printout.

18. A computer program product according to claim 17 wherein the module is designed such that control parameters for the print jobs are read from different sources, whereby priorities are associated with the sources and, if specific control parameters are present in multiple sources, the control parameters are used from those sources that possess a highest priority.

19. A computer program product according to claim 11 wherein the computer program product is stored on a data medium.

20. A printing system, comprising:
a print server in which a computer program product is stored and can be executed; and
the computer program product performing the steps of:
repeatedly executing a checking of the directory as to whether a new file has been generated in the respective directory, said checking comprising the steps of
reading a current directory modification time that corresponds to a point-in-time of a last modification of the corresponding directory,
comparing the current directory modification time with a stored directory modification time, and, given a difference between the two directory modification times, this is assessed as a modification of the respective directory since the last check of said respective directory, and
in the event that such a modification of the directory has occurred, examining the directory by a detailed check for new files generated in the directory and storing the current modification time.

21. A method for monitoring of a directory in a computer system as to whether a new file has been generated in the directory, comprising the steps of:
repeatedly executing a checking of the directory as to whether a new file has been generated in the respective directory, the checking comprising the steps of:
checking for presence of a trigger file which is associated with a specific file in the directory; and
if the trigger file is present, releasing the associated specific file for further processing.

22. A method of claim 21 wherein said trigger file is generated after complete creation of a print job corresponding to said specific file in the directory.

23. A method of claim 22 wherein the complete creation of the print job comprises all files belonging to the print job are completely generated and with all processes relevant for the writing of the files of the print job have been ended without errors.

24. A method of claim 21 wherein the trigger file has a same name as a print job corresponding to said specific file but with a specific change appended to the file name.

25. A method of claim 21 wherein the trigger file contains no data.

26. A printing system, comprising:
a print server in which a computer program product is stored and can be executed; and
the computer program product performing the steps of:
repeatedly executing a checking of the directory as to whether a new file has been generated in the respective directory, said checking comprising the steps of
checking for presence of a trigger file which is associated with a specific file in the directory; and
if the trigger file is present, releasing the associated specific file for further processing.
